(19) United States
(12) Patent Application Publication
(10) Pub. No.: US 2025/0016072 A1
(43) Pub. Date: Jan. 9, 2025

(54) DETECTING NETWORK FUNCTION CAPACITY DEVIATIONS IN 5G NETWORKS

(71) Applicant: TELEFONAKTIEBOLAGET LM ERICSSON (PUBL), Stockholm (SE)

(72) Inventors: Javier Campo Trapero, Madrid (ES); Pedro Bermudez Garcia, Torrox-costa (ES); Miguel Angel Muñoz De La Torre Alonso, Madrid (ES)

(21) Appl. No.: 18/708,754

(22) PCT Filed: Mar. 30, 2022
(86) PCT No.: PCT/IB2022/052968

§ 371 Date: May 9, 2024

(30) Foreign Application Priority Data
Nov. 30, 2021 (EP) 21383078.9

(51) Int. Cl. H04L 41/5025; H04L 41/142; H04L 41/16

(52) U.S. Cl. CPC H04L 41/5025; H04L 41/142; H04L 41/16

(57) ABSTRACT

Embodiments include methods for a network data analytics function (NWDAF) of a communication network. Such methods include obtaining, from an operations administration maintenance (OAM) network function (NF) of the communication network, the following information for each of one or more target NF instances in the communication network: an identifier of the target NF instance: a NF type associated with the target NF instance: resource usage by the target NF instance; and resource configuration of the target NF instance. Such methods also include computing analytic(s) related to deviation in processing load or capacity of the target NF instances, based on the information obtained from the OAM NF and on a capacity dimensioning model for each target NF instance. Such methods also include sending, to a consumer NF of the communication network, a message including the computed analytic(s). Other embodiments include complementary methods for the OAM NF and the consumer NF.

### TECHNICAL FIELD

The present application relates generally to the field of communication networks, and more specifically to techniques for detecting deviations in capacities of network functions in 5G core (5GC) networks, such as based on analytics.

### INTRODUCTION

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region” with the term “AMF” referring to an access and mobility management function in the 5GC.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs are logical nodes that host higher-layer protocols and perform various gNB functions such controlling the operation of DUs, which are decentralized logical nodes that host lower layer protocols and can include various subsets of gNB functions. Each of the CUs and DUs can include various circuitry needed to perform their respective functions, such as processing circuitry, communication interface (e.g., transceiver) circuitry, and power supply circuitry.

A gNB-CU connects to one or more gNB-DUs over respective F1 logical interfaces, such as interfaces 122 and 132 shown in FIG. 1. A gNB-DU can be connected to only a single gNB-CU, with the gNB-CU and connected gNB-DU(s) appearing to other gNBs and the 5GC as a unitary gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations,” which are more granular divisions of the overall service functionality. The interactions between service consumers and producers can be of the type “request/response” or “subscribe/notify.” In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

### SUMMARY

Capacity of 5G network deployments is difficult to characterize and/or predict for various reasons. Even so, mobile network operations (MNOs) may require (e.g., by contract) a particular capacity for a deployed network supplied by an equipment vendor. Due to these difficulties, however, the actual capacity of the deployed network may deviate significantly from the required capacity. There is no automatic procedure to detect such network capacity deviations in real-time.

Embodiments of the present disclosure address these and other problems, issues, and/or difficulties, thereby facilitating the otherwise-advantageous deployment of ML models for analytics in 5G networks.

Some embodiments include exemplary methods (e.g., procedures) for a network data analytics function (NWDAF) of a communication network (e.g., 5GC). These exemplary methods can include obtaining, from an operations administration maintenance (OAM) network function (NF) of the communication network, the following information for each of one or more target NF instances in the communication network:
an identifier of the target NF instance;
a NF type associated with the target NF instance;
resource usage by the target NF instance; and
resource configuration of the target NF instance.

These exemplary methods can also include computing one or more analytics related to deviation in processing load or capacity of the target NF instances, based on the information obtained from the OAM NF and on a capacity dimensioning model for each target NF instance. These exemplary methods can also include sending, to a consumer NF of the communication network, a message including the computed one or more analytics.

In some embodiments, these exemplary methods can also include receiving, from the consumer NF, a subscription request for a capacity analytic associated with the one or more target NF instances. The computed one or more analytics are sent in response to the subscription request. In some embodiments, the subscription request can include an identifier of the requested capacity analytic and one or more tuples, with each tuple including the following:
an identifier of a target NF instance or a target NF type;
an indication of whether a capacity dimensioning model is requested for the identified target NF instance or type; and
an indication of committed capacity for the identified target NF instance or instances of the identified target NF type.

In some embodiments, the subscription request also includes a capacity deviation margin associated with the requested capacity analytic.

In some embodiments, obtaining the information from the OAM NF can include sending, to the OAM NF, a request including one or more tuples corresponding to the one or more target NF instances identified by the subscription request. Each tuple includes an identifier of a target NF instance and a NF type associated with the target NF instance. Such embodiments also include receiving the information from the OAM NF in response to the request.

In some embodiments, these exemplary methods can also include sending a request to a network repository function (NRF) of the communication network. The request can include one or more tuples corresponding to the one or more target NF instances identified by the subscription request. Each tuple includes an identifier of a target NF instance and a NF type associated with the target NF instance. Such embodiments can also include receiving, from the NRF, NF profile information for the target NF instances identified in the request. The NF profile information for each target NF instance includes one or more of the following: current status, load at a corresponding time (e.g., timestamp), and capacity. In such case, computing the one or more analytics can be further based on the NF profile information.

In some embodiments, the target NF instances are instances of a user plane function (UPF), and these exemplary methods can also include obtaining a traffic usage report from the UPF. In such case, computing the one or more analytics can be further based on the traffic usage report.

In some embodiments, the message sent to the consumer NF includes the following, for each of the computed one or more analytics:
an identifier of the analytic; and
an identifier of a capacity dimensioning model used to compute the analytic, when requested in the subscription request from the consumer NF;
identifiers of target NF instances having capacity deviations;
the respective capacity deviations; and
respective confidence levels or confidence intervals for the capacity deviations.

In some of these embodiments, the message sent to the consumer NF also includes indication of one or more the following, for each target NF instance having capacity deviation: a capacity-limiting resource; a feature causing the capacity deviation; and a duration until the target NF instance will reach a capacity limit.

In some embodiments, the resource usage by the one or more target NF instances includes respective values of one or more performance counters maintained by the OAM NF for each of the target NF instances. In some embodiments, the resource configuration of the one or more target NF instances includes indications of one or more of the following, for each of the target NF instances:
characteristics of processing chipset used;
build and/or release of software used;
NF deployment type;
virtual machine (VM) configuration;
number of VMs or physical machines (PMs) currently used;
maximum number of available VMs or PMs;
processing redundancy scheme; and
networking capacity.

In some embodiments, the indication of resource usage by the target NF instances comprises values for a plurality of performance counters maintained by the OAM NF. In such embodiments, the capacity dimensioning model is a multiple linear regression ML model based on the plurality of performance counter values and on a corresponding plurality of processing costs per data packet. In addition, the one or more analytics computed for each target NF instance are related to total processing load.

In some of these embodiments, these exemplary methods can also include training the multiple linear regression ML model based on training data related to hour of day when the target NF has the highest traffic level (e.g., “busy hour”). The training data can include actual processing load and corresponding actual values for the plurality of performance counters.

Other embodiments include methods (e.g., procedures) for a consumer NF of a communication network (e.g., 5GC). These exemplary methods can include sending, to a NWDAF of the communication network, a subscription request for a capacity analytic associated with one or more target NF instances in the communication network. These exemplary methods can also include receiving, from the NWDAF in accordance with the subscription request, a message including one or more analytics related to deviation in processing load or capacity of the target NF instances. Each of the received analytics is based on a capacity dimensioning model for each target NF instance. These exemplary methods can also include, based on the received one or more analytics, performing one or more operations related to the capacity dimensioning model and/or to the target NF instances.

In various embodiments, the subscription request can include any of the information summarized above in relation to the NWDAF embodiments. In some embodiments, each capacity analytic can also be based on one or more of the following:
resource usage by the target NF instances and resource configuration of the target NF instances, as maintained by an OAM NF of the communication network;
NF profile information for the target NF instances, as maintained by an NRF of the communication network; and
a traffic usage report by a UPF of the communication network.

In some of these embodiments, the resource usage by the target NF instances is indicated by values for a plurality of performance counters maintained by the OAM NF. In such embodiments, the capacity dimensioning model is a multiple linear regression ML model based on the plurality of performance counter values and on a corresponding plurality of processing costs per data packet. In addition, the one or more analytics received for each target NF instance are related to total processing load.

In various embodiments, the resource configuration of the one or more target NF instances can include any of the information summarized above in relation to the NWDAF embodiments. In various embodiments, the message received from the can include any of the information mentioned above in relation to the corresponding message sent by the NWDAF.

In some embodiments, the one or more operations related to the capacity dimensioning and/or to the target NF instances include any of the following:
using the capacity dimensioning model, received from the NWDAF in the message, for dimensioning of the target NF instances;
triggering a fault management (FM) alarm indicating a possible cause of an actual or expected capacity deviation for one or more of the target NF instances;
triggering a FM alarm indicating that capacity is close to a limit for one or more of the target NF instances; and
initiating retraining of a capacity dimensioning model for a NF type corresponding to one or more of the target NF instances in which a capacity deviation occurred or is expected to occur.

Other embodiments include methods (e.g., procedures) for an OAM NF of a communication network (e.g., 5GC). These exemplary methods can include receiving, from an NWDAF of the communication network, a request including one or more tuples. Each tuple includes an identifier of a target NF instance in the communication network and a NF type associated with the target NF instance. These exemplary methods can also include sending, to the NWDAF in response to the request, the following information for each of the target NF instances identified in the request:
the identifier of the target NF instance;
the NF type associated with the target NF instance;
resource usage by the target NF instance; and
resource configuration of the target NF instance.

In some embodiments, the indication of resource usage by the one or more target NF instances includes respective values of one or more performance counters maintained by the OAM NF for each of the target NF instances. In various embodiments, the resource configuration of the one or more target NF instances can include any of the information summarized above in relation to the NWDAF embodiments.

In some embodiments, for each of target NF instances identified in the request, the response to the request includes a tuple comprising:
the identifier of the target NF instance;
the NF type associated with the target NF instance;
an average usage of virtual CPU resources for the target NF instance;
an average usage of virtual memory resources for the target NF instance;
an average usage of virtual disk storage resources for the target NF instance; and
an indication of resource configuration changes for the target NF instance.

Other embodiments include NWDAFs, consumer NFs, and OAM NFs (or network nodes hosting the same) that are configured to perform the operations corresponding to any of the exemplary methods described herein. Other embodiments also include non-transitory, computer-readable media storing computer-executable instructions that, when executed by processing circuitry, configure such NWDAFs, consumer NFs, and OAM NFs to perform operations corresponding to any of the exemplary methods described herein.

These and other disclosed embodiments can apply capabilities of 5G networks to detect NF capacity deviations automatically and/or in real time based on NWDAF analytics. Embodiments can enable consumers (e.g., consumer NF associated with an MNO) to retrieve capacity dimensioning models, to use such models as required, and to trigger FM alarms due to capacity deviations. Embodiments also facilitate elimination of offline capacity dimensioning tools that may outdated, do not cover all deployment variations, and require a lot of maintenance and testing efforts. At a high level, embodiments improve management of available capacity in communication networks (e.g., 5GC).

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3, which includes FIGS. 3A-C, shows an exemplary procedure for . . . , according to various embodiments of the present disclosure.

FIG. 4 shows an exemplary method (e.g., procedure) for an NWDAF of a communication network, according to various embodiments of the present disclosure.

FIG. 5 shows an exemplary method (e.g., procedure) for a consumer NF of a communication network, according to various embodiments of the present disclosure.

FIG. 6 shows an exemplary method (e.g., procedure) for an OAM NF of a communication network, according to various embodiments of the present disclosure.

FIG. 7 shows a communication system according to various embodiments of the present disclosure.

FIG. 8 shows a UE according to various embodiments of the present disclosure.

FIG. 9 shows a network node according to various embodiments of the present disclosure.

FIG. 10 shows host computing system according to various embodiments of the present disclosure.

FIG. 11 is a block diagram of a virtualization environment in which functions implemented by some embodiments of the present disclosure may be virtualized.

FIG. 12 illustrates communication between a host computing system, a network node, and a UE via multiple connections, according to various embodiments of the present disclosure.

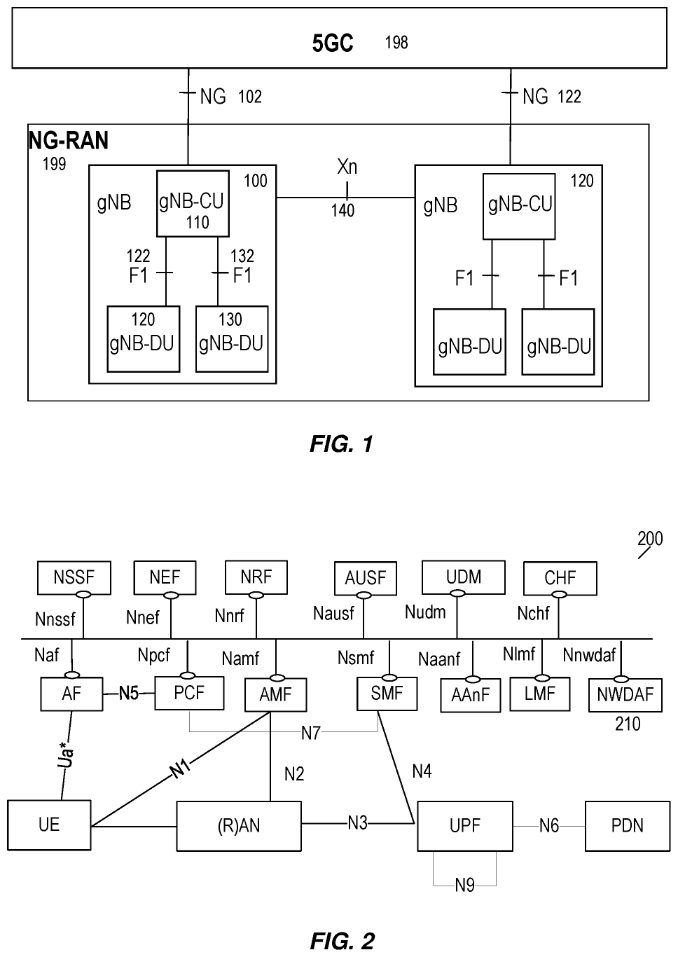

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, mobile terminals (MTs), etc.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device.
Service: As used herein, the term “service” refers generally to a set of data, associated with one or more applications, which is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

FIG. 2 shows an exemplary non-roaming reference architecture for a 5G network (200). These include the following 3GPP-defined NFs and service-based interfaces:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface-acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface-provides service registration and discovery, enabling NFs to identify appropriate services available from other NFs.
Network Slice Selection Function (NSSF) with Nnssf interface-a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface-based in a user's home network (HPLMN), it performs user authentication and computes security key materials for various purposes.
Network Data Analytics Function (NWDAF, 210) with Nnwdaf interface, described in more detail above and below.
Location Management Function (LMF) with Nlmf interface-supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3GPP Rel-17 enhances the SBA by adding a Data Management Framework that includes a Data Collection Coordination Function (DCCF) and a Messaging Framework Adaptor Function (MFAF), which are defined in detail in 3GPP TR 23.700-91 (v17.0.0). The Data Management Framework is backward compatible with a Rel-16 NWDAF function, described above. For Rel-17, the baseline for services offered by the DCCF (e.g., to an NWDAF Analytics Function) are the Rel-16 NF Services used to obtain data. For example, the baseline for the DCCF service used by an NWDAF consumer to obtain UE mobility data is Namf_EventExposure.

A 5GC NF of particular interest in the present disclosure is the NWDAF. This NF can collect data from any NF and can provide network analytics information (e.g., statistical information of past events and/or predictive information) to other NFs on a per-network slice instance granularity. Note that a “network slice” is a logical partition of a 5G network that provides specific network capabilities and characteristics, e.g., in support of a particular service. A “network slice instance” is a set of NF instances and the required network resources (e.g., compute, storage, communication) that provide the capabilities and characteristics of the network slice.

3GPP TS 23.288 (v17.2.0) specifies that NWDAF is the main network function for computing analytics reports and classifies NWDAF into two sub-functions (or logical functions): NWDAF Analytics Logical Function (NWDAF AnLF), which performs analytics procedures; and NWDAF Model Training Logical Function (NWDAF MTLF), which performs training and retraining of ML models used by NWDAF AnLF. The services used by these NWDAF logical functions work on an implicit assumption of a one-to-one relationship between ML model and Analytics identifier (ID), also referred to as “NwdafEvent”.

The 5G system architecture allows any NF to obtain analytics from an NWDAF using a DCCF function and associated Ndccf services. The NWDAF can also perform storage and retrieval of analytics information from an Analytics Data Repository Function (ADRF).

The models trained and used by the NWDAF to compute analytics may be associated with machine learning (ML) algorithms. ML is a type of artificial intelligence (AI) that focuses on the use of data and algorithms to imitate the way that humans learn, gradually improving its accuracy. ML algorithms build models based on sample (or “training”) data, with the models being used subsequently to make predictions or decisions. ML algorithms can be used in a wide variety of applications (e.g., medicine, email filtering, speech recognition, etc.) in which it is difficult or unfeasible to develop conventional algorithms to perform the needed tasks. A subset of ML is closely related to computational statistics.

One type of ML algorithm is “supervised learning.” These algorithms involve a target variable (also referred to as “outcome variable” or “dependent variable”) to be predicted from a given set of predictors (also referred to as “independent variables”). These variables are used to generate a function that maps inputs to desired outputs. The training process continues until the model achieves a desired level of accuracy on the training data. Examples of supervised learning algorithms include regression, logistic regression, decision tree, random forest, KNN, etc.

Another type of ML algorithm is “unsupervised learning.” These algorithms do not include any target or outcome variables to predict and/or estimate. Instead, these algorithms are typically used for clustering populations into different groups, e.g., for group-specific intervention. Examples of unsupervised learning algorithms include K-means, mean-shift clustering, density-based spatial clustering of applications with noise (DBSCAN), expectation-maximization (EM) clustering using Gaussian mixture models (GMM), agglomerative hierarchical clustering, etc.

As a further example, cluster analysis (or clustering) is a ML technique which groups a set of objects in such a way that objects in the same group (or “cluster”) are more similar to each other (e.g., according to some criteria) than to objects in other clusters. Clustering is often a primary task of exploratory data mining and a common statistical data analysis technique used in many fields, such as pattern recognition, image analysis, information retrieval, bioinformatics, data compression, computer graphics, etc.

Another type of ML algorithm is “reinforcement learning.” These algorithms train a machine to make specific decisions. In particular, the machine is exposed to an environment in which it trains itself continually using trial and error. The machine learns from experience and tries to capture the best possible knowledge to make accurate decisions in the future. One example of reinforcement learning is the Markov Decision Process.

As briefly mentioned above, capacity of 5G network deployments is difficult to characterize and/or predict. One reason is differences in NF deployment including physical NFs (PNFs), containerized NFs (CNFs), and virtualized NFs (VNFs). Other reasons include changes in functionality per NF (e.g., in different 3GPP releases) and changes in software and hardware implementations of this functionality. Other reasons include variations in network traffic.

Currently manual processes are typically used to build and maintain network capacity dimensioning models. These processes often include providing capacity test results to an offline capacity dimensioning tool, which can provide capacity models that must be validated based on statistics from live network tests. This may result in re-dimensioning capacity and/or changing the capacity model.

MNOs may require (e.g., by contract) an equipment vendor to provide a specific capacity for a deployed network. Due to the difficulties discussed above, however, the actual capacity of the deployed network may deviate significantly from the required capacity. Currently, there is no automatic procedure to detect such network capacity deviations in real-time.

Accordingly, embodiments of the present disclosure address these and other problems, issues, and/or difficulties by providing techniques that use analytics capabilities of 5G networks to detect NF capacity deviations in real time (e.g., substantially concurrent with, or an insignificant delay after, occurrence of the deviation). Such techniques can enable an MNO to automate detection of NF capacity deviations based on NWDAF-computed analytic(s). Additionally, such techniques can enable an MNO to retrieve a capacity dimensioning model per NF type and/or instance.

These techniques provide various benefits and/or advantages. For example, they allow an MNO to detect NF capacity deviations automatically in real time, and to expose this information to consumers that can take needed actions such as triggering a fault management (FM) alarm indicating NF capacity is close to a limit (e.g., to be reached in some period according to predicted traffic trend) or a possible root cause of the deviation (e.g., increased CPU processing cost per packet rate (PPS) associated with specific performance counter). Additionally, the detected NF capacity deviations can trigger retraining of a dimensioning model for the NF type in which the capacity deviation occurred.

Additionally, these techniques can allow an MNO to eliminate offline capacity dimensioning tools that may outdated, do not cover all possible deployment variations, and require a lot of maintenance and testing efforts. More generally, techniques facilitate automation of the NF capacity dimensioning process, which is done manually and/or offline.

Embodiments can be summarized at a high level as follows. A consumer (e.g., NF) subscribes to NWDAF for a new type of analytic (e.g., Analytic-ID=nfCapacity) by triggering a Nnwdaf_AnalyticsSubscription_Subscribe request message including one or more of the following information elements (IEs) and/or fields:
Analytic-ID set to “nfCapacity”
List of (nfType or nfInstanceId, nfCapacityModelRequested, nfCommitedCapacity) tuples. Each tuple indicates type of target NF (nfType, e.g., UPF) or specific NF instances (nfInstanceId, e.g., specific UPF instance) and whether or not a capacity model is requested for each type or instance. Additionally, each tuple indicates the committed capacity for the identified type or instance, e.g., x Gbps at 80% CPU load in UPF instance 1, y Gbps at 80% CPU load in UPF instance 2, etc.
devMargin, which indicates acceptable capacity deviation margin (e.g., +/−10%).
timePeriod, which indicates a time period applicable for the requested analytic.
confidenceLevel, which indicates a required confidence level for the requested analytic.
Other analytics filter information such as area of interest, data network name (DNN), Single Network Slice Selection Assistance Information (S-NSSAI), RAT-Type, etc.

Based on the received analytic subscription, NWDAF triggers data collection from the following network functions:
From operations administration maintenance (OAM) NF or OAM module in the target NF (e.g., UPF) relative to ResourceUsage and ResourceConfiguration, including retrieval of any of the following information:
   Performance counters: CPU load, memory load, disk load, PPS, Gbps, interfaces transactions per second (TPS), IP sessions, subscribers, list of feature counters.
   Characteristics of chipset used.
   Build and/or release of software used.
   Deployment type, e.g., PNF, CNF, VNF, etc.
   NF configuration, e.g., number of vCPUs per VM or container or physical blade, vRAM and vDisk size allocated per VM or container or physical blade, etc.
   Current and maximum PNF/CNF/VNF size, e.g., number of VM, PODS or physical blades per NF, etc.
   Networking resources, e.g., NIC capacity, etc.
   Redundancy schema, e.g., N+1, N+M, etc.
From NRF relative to NFProfileRetrieval, specifically NF status, capacity, and load.
From target NF (type/instance), e.g., from UPF if the analytic refers to UPF capacity deviation. For example, collected information can include Traffic Usage Reports that allow NWDAF to derive the traffic mix for an average user PDU session, which may be relevant for UPF dimensioning.

Based on this collected data, the NWDAF runs analytic processes and generates the analytics output with the following IEs and/or fields:
Analytic-ID=“nfCapacity”
Analytic-Result, including:
   List of nfCapacityModel, in case the consumer requested the NF capacity model.
   List of nfInstanceId that correspond to NF instances having capacity deviation.
   For each nfInstanceId in the above list:
      Resulting capacity deviation, e.g., 20% worse capacity than expected.
      Confidence metric, e.g., 95% confidence that capacity deviation has occurred or will occur.
      (Optional) Indication of capacity limiting factor, e.g., CPU, memory, disk, etc.
      (Optional) Feature/s capacity deviation (that might indicate deviation detected for specific capacity cost associated to a feature or performance counter).
      (Optional) TimeToCapacityLimit indicating how time (e.g., days/hours) until the NF instance is going to reach its capacity limit.

The consumer can take various actions based on the analytic output received from NWDAF, including any of the following:
use any received nfCapacityModel for network dimensioning purposes,
trigger FM alarm for any nfInstanceId in the list, indicating possible root cause of the deviation (e.g., increased CPU processing cost for PPS associated with specific performance counter);
trigger FM alarm for any nfInstanceId in the list, indicating NF capacity is close to a limit (e.g., to be reached in some period according to predicted traffic trend); and
retraining of a dimensioning model for the NF type (e.g., UPF) in which the capacity deviation occurred or is expected to occur.

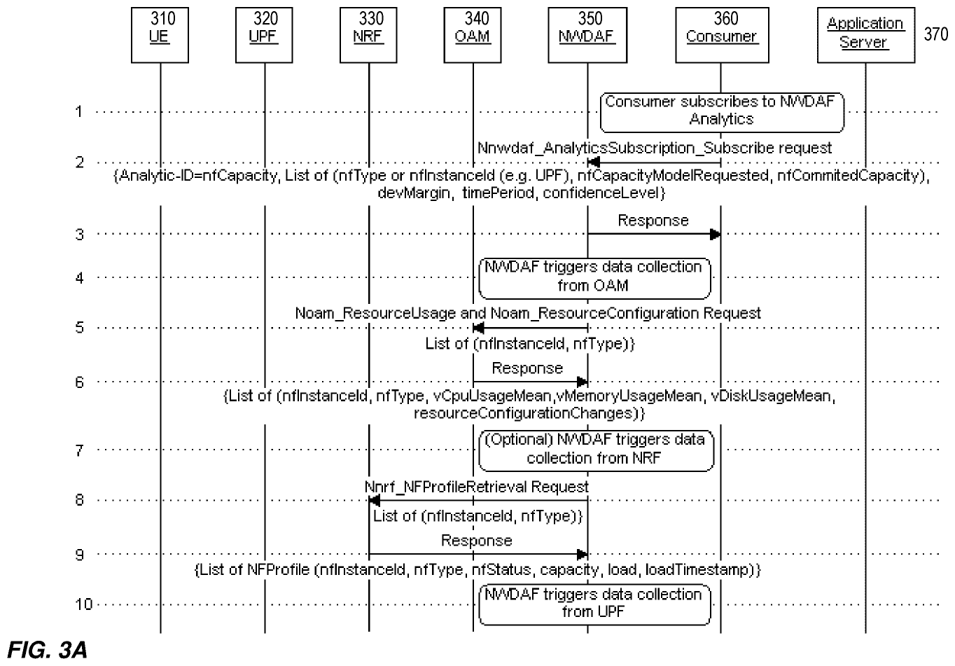

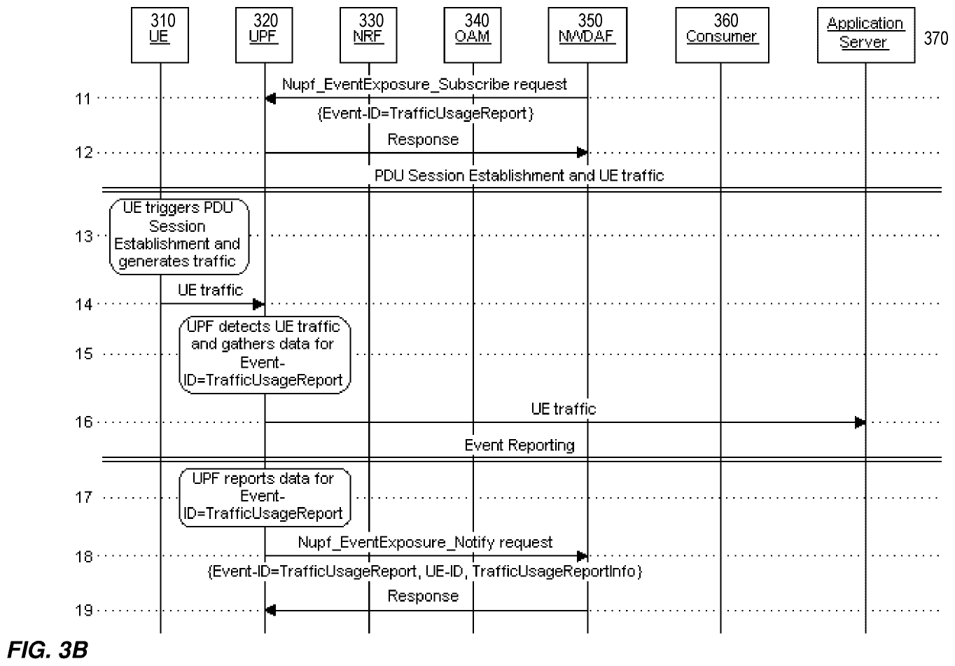

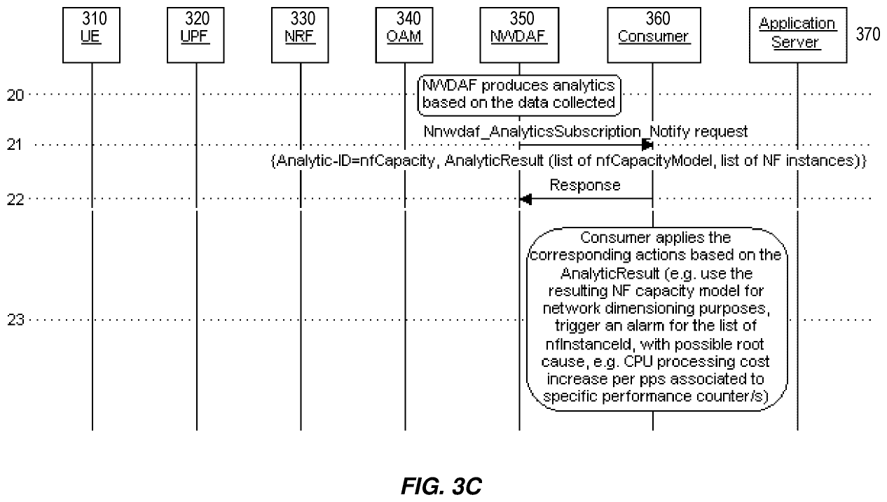

FIG. 3, which includes FIGS. 3A-C, shows a signaling diagram that illustrates various embodiments in the context of detecting UPF capacity deviations. This merely exemplary and skilled person will recognize that principles illustrated by FIG. 3 are applicable to detecting capacity deviations of other NFs. Although FIG. 3 shows numbered operations, this numbering is intended to facilitate the following description rather than to imply or require a particular order of operation, unless expressly stated to the contrary.

In operations 1-2, a consumer (360, e.g., consumer NF) subscribes to an NWDAF (350) for an analytic identified by Analytic-ID=nfCapacity by sending an Nnwdaf_Analytics-Subscription_Subscribe request message including the following parameters:
Analytic-ID=nfCapacity
List of (nfType or nfInstanceId, nfCapacityModelRequested, nfCommitedCapacity) tuples. Each tuple indicates type of target NF (nfType, e.g., UPF) or specific NF instances (nfInstanceId, e.g., specific UPF instance) and whether a capacity model is requested for each type or instance. Additionally, each tuple indicates the committed capacity for the identified type or instance, e.g., x Gbps at 80% CPU load in UPF instance 1, y Gbps at 80% CPU load in UPF instance 2, etc.
   Although the nfCommitedCapacity parameter is not currently defined by 3GPP, committed capacity per NF instance is commonly used in Bid of Quantity/Material contract between the MNO and network vendor, e.g., for any deployed NF of specific HW and SW versions. The nfCommittedCapacity may be expressed as a data structure including one or more of the following fields:
      Committed Gbps or MPPS per blade, VM, or container;
      Committed interface TPS per blade or VM or container (e.g., N4 interface for UPF);
      Committed maximum number of IP sessions per blade, VM, or container;
      Committed maximum peak user rate (e.g., 5 Gbps), e.g., when target NF is UPF.
devMargin, which indicates acceptable capacity deviation margin (e.g., +/−10%).
timePeriod, which indicates a time period applicable for the requested analytic.
confidenceLevel, which indicates a required confidence level for the requested analytic.
(Optional) Other analytics filter information such as area of interest, data network name (DNN), Single Network Slice Selection Assistance Information (S-NSSAI), RAT-Type, etc.

In operation 3, the NWDAF answers the consumer indicating successful operation on the subscribe request. In operations 4-5, the NWDAF triggers data collection from OAM (340, e.g., an OAM NF or an OAM module in the target UPF) relative to ResourceUsage and ResourceConfiguration, including retrieval of any of the following information relative to ResourceUsage and ResourceConfiguration, by sending Noam_ResourceUsage and Noam_ResourceConfiguration Request message including a list of (nfInstanceId, nfType) tuples associated with the target NF.

In operation 6, OAM responds to the message operation 5 with a list of (nfInstanceId, nfType, vCpuUsageMean, vMemoryUsageMean, vDiskUsageMean, resourceConfiguration-Changes) tuples concerning the resource configuration. The first two items in each tuple correspond to the tuples received in operation 5. Additionally, the response in operation 6 can include the following information:
Performance counters: CPU load, memory load, disk load, PPS, Gbps, interfaces transactions per second (TPS), IP sessions, subscribers, list of feature counters.
Characteristics of processing chipset used.
Build and/or release of software used.
Deployment type, e.g., PNF, CNF, VNF, etc.
NF virtual machine (VM) configuration, e.g., number of vCPUs per VM or container or physical blade, vRAM and vDisk size allocated per VM or container or physical blade, etc.
Current and maximum PNF/CNF/VNF size, e.g., number of VM, PODS or physical blades per NF, etc.
Networking resources, e.g., NIC capacity, etc.
Redundancy schema, e.g., N+1, N+M, etc.

In operations 7-8, which are optional, the NWDAF triggers data collection from NRF (330) relative to NFProfileRetrieval, specifically to retrieve the NF status, capacity and load, by triggering a Nnrf_NFProfileRetrieval Request message including a list of (nfInstanceId, nfType) tuples associated with the target NF (e.g., UPF). In operation 9, the NRF responds to the request of operation 8 with a list of NFProfile tuples, each including (nfInstanceId, nfType, nfStatus, capacity, load, loadTimestamp).

Note that this NFProfile tuple, as it is currently defined by 3GPP, provides very limited information that is insufficient for the NWDAF to compute the desired analytic result. As such, the data collection from NRF is optional with data collection from OAM (mostly PM counters) being the main source of data used by the NWDAF to compute the desired analytic result. Thus, it is unnecessary to extend the current NFProfile tuple to include more granular parameters.

In operations 10-11, the NWDAF triggers data collection from UPF (320) relative to Traffic Usage Reports by sending a Nupf_EventExposure_Subscribe request including an Event-ID=TrafficUsageReport. Existing mechanisms described in 3GPP TR 23.700-91 (v17.0.0) can be used for data collection directly from UPF or indirectly via SMF or directly.

In operation 12, the UPF answers NWDAF indicating successful operation. In operations 13-14, a UE (310) triggers PDU Session Establishment and generates traffic. In operation 15, the UPF detects the UE traffic and gathers relevant data for Event-ID=TrafficUsageReport received in operation 11. UPF forwards the UE traffic to the relevant application server (370) in operation 16. The UPF continues gathering data for Event-ID=TrafficUsageReport and (at some point) in operations 17-18 reports data for Event-ID=TrafficUsageReport by triggering a Nupf_EventExposure_Notify request including the following parameters:
Event-ID=TrafficUsageReport;
UE-ID, of the UE generating the traffic (optional);
TrafficUsageReportInfo, e.g., user plane activity, volume split per application or application type, number of flows, etc.

In operation 19, the NWDAF responds to the UPF indicating successful operation on the request in operation 18. In operation 20, the NWDAF produces analytics based on the data collected from OAM, UPF, and (optionally) NRF. Specifically, the NWDAF derives the list of NF instances for which capacity deviations have occurred or are predicted to occur. For example, the NWDAF can use a previously trained ML model to compute these analytics and can continuously validate the ML model based on collected data. Alternately, the NWDAF can build a capacity dimensioning model for each NF type (e.g., UPF), primarily based on performance counters.

In general, creation of a capacity dimensioning model per NF type and/or NF instance is a prerequisite for identifying capacity deviation. However, if a capacity dimensioning model does not exist initially for a given NF type and/or instance, the NWDAF can build the missing capacity dimensioning model(s). Data needed to build a capacity dimensioning model include resources load (e.g., vCPU type load) and NF instance performance counters representative of the model.

An example capacity dimensioning model for CPU load can be based on multiple linear regression of CPU cost per PPS for various performance counters. Multiple linear regression is a type of supervised ML technique in which the ML model is trained with known variables “y” and “x” sampled at specific times (e.g., every 15 minutes during Busy Hour, which is the hour of day with highest traffic). For example, “y” represents the actual resource type load (e.g., average Payload CPU load) at a specific time while “x” represents the actual performance counter value at the specific time (e.g., accounted traffic in PPS).

The multiple linear regression model can be expressed as:

$$\hat{y} = {\hat{β}}_{0} + {\hat{β}}_{1} {x}_{1} + {\hat{β}}_{2} {x}_{2} + ... + {\hat{β}}_{n} {x}_{n}$$

where \hat{β}ᵢ represents the processing cost (e.g., CPU load spent per data payload packet) for each performance counter xᵢ and \hat{β}₀ represents CPU baseload to infer during ML model training. NWDAF may run multiple regression as a candidate algorithm and determine the \hat{β}ᵢ values for the ML model based on training data samples taken during some number of hours and/or days.

This ML model can also be expressed as:

$$CPU load = CPU baseload + Performance counter 1 \times CPU cost per PPS for counter 1 + Performance counter 2 \times CPU cost per PPS for counter 2 + ... Performance counter N \times CPU cost per PPS for counter N .$$

To select an appropriate capacity dimensioning model for a given NF instance, the NWDAF can assess multiple datasets to select most relevant features or performance counters and assess multiple ML algorithms (e.g., multiple linear regression, neural network, etc) to select the most relevant ML algorithm. For example, the NWDAF can benchmark different candidate capacity dimensioning models, train those candidate models using different input subsets of training data, verify the performance of the candidate models according to some criteria (e.g., prediction mean square error), and select the ML model that gives the highest capacity prediction accuracy.

The NWDAF can also collect other NF metadata that is complementary to the ML model inputs and can be used to predict capacity deviations, maximum capacities, etc. Such metadata can include any of those discussed above in relation to operation 6.

Based on this, NWDAF obtains a NF capacity dimensioning model and determines (e.g., based on computing the analytics) whether capacity deviation is occurring or is expected to occur for each NF instance subscribed by the consumer in operations 1-2. In operation 21, the NWDAF reports the analytic output to the consumer by sending Nnwdaf_AnalyticsSubscription_Notify request message, including the following information:
Analytic-ID=“nfCapacity”
Analytic-Result, including:
   List of nfCapacityModel, in case the consumer requested the NF capacity model.
   List of nfInstanceId that correspond to NF instances having capacity deviation.
   For each nfInstanceId in the above list:
      Resulting capacity deviation, e.g., 20% worse capacity than expected.
      Confidence metric, e.g., 95% confidence that capacity deviation has occurred or will occur.
      (Optional) Indication of capacity limiting factor, e.g., CPU, memory, disk, etc.
      (Optional) Feature/s capacity deviation (that might indicate deviation detected for specific capacity cost associated to a feature or performance counter).
      (Optional) TimeToCapacityLimit indicating how time (e.g., days/hours) until the NF instance is going to reach its capacity limit.

In operation 22, the consumer responds to NWDAF indicating successful operation. In operation 23, the consumer performs one or more actions based on the Analytic-Result obtained in operation 21, including any of the following:
use any received nfCapacityModel for network dimensioning purposes;
trigger FM alarm for any nfInstanceId in the list, indicating possible root cause of the deviation (e.g., increased CPU processing cost for PPS associated with specific performance counter);
trigger FM alarm for any nfInstanceId in the list, indicating NF capacity is close to a limit (e.g., to be reached in some period according to predicted traffic trend); and
initiate retraining of a capacity dimensioning model for the NF type (e.g., UPF) in which the capacity deviation occurred or is expected to occur.

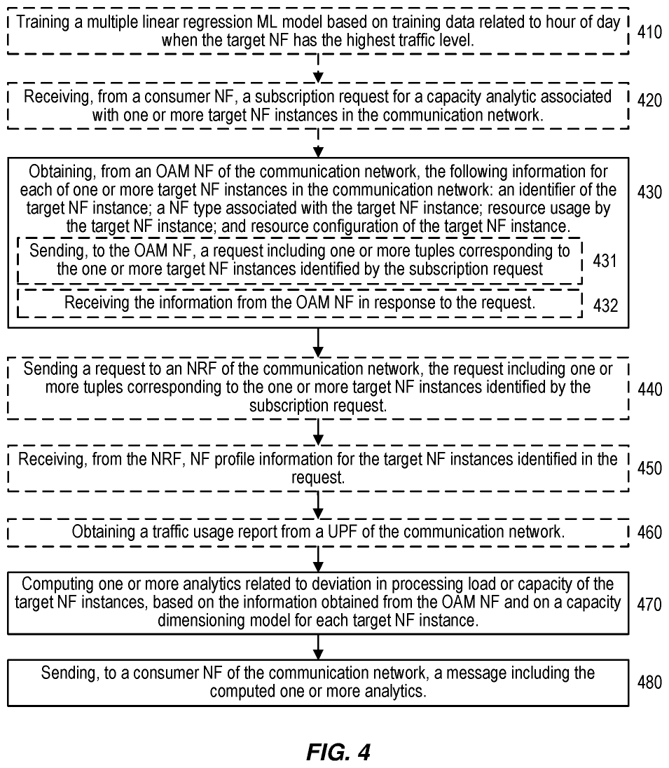

The embodiments described above can be further illustrated with reference to FIGS. 4-6, which depict exemplary methods (e.g., procedures) for an NWDAF, a consumer NF, and an OAM NF, respectively. Put differently, various features of the operations described below correspond to various embodiments described above. The exemplary methods shown in FIGS. 4-6 can be used cooperatively (e.g., with each other and with other procedures described herein) to provide benefits, advantages, and/or solutions to problems described herein. Although the exemplary methods are illustrated in FIGS. 4-6 by specific blocks in particular orders, the operations corresponding to the blocks can be performed in different orders than shown and can be combined and/or divided into blocks and/or operations having different functionality than shown. Optional blocks and/or operations are indicated by dashed lines.

In particular, FIG. 4 illustrates an exemplary method (e.g., procedure) for a NWDAF of a communication network (e.g., 5GC), according to various embodiments of the present disclosure. The exemplary method shown in FIG. 4 can be performed by an NWDAF or a network node hosting an NWDAF, such as described elsewhere herein.

The exemplary method can include the operations of block 430, where the NWDAF can obtain, from an OAM NF of the communication network, the following information for each of one or more target NF instances in the communication network:
an identifier of the target NF instance;
a NF type associated with the target NF instance;
resource usage by the target NF instance; and
resource configuration of the target NF instance.

The exemplary method can also include the operations of block 470, where the NWDAF can compute one or more analytics related to deviation in processing load or capacity of the target NF instances, based on the information obtained from the OAM NF and on a capacity dimensioning model for each target NF instance. The exemplary method can also include the operations of block 480, where the NWDAF can send, to a consumer NF of the communication network, a message including the computed one or more analytics.

In some embodiments, the exemplary method can also include the operations of block 420, where the NWDAF can receive, from the consumer NF, a subscription request for a capacity analytic associated with the one or more target NF instances. The computed one or more analytics are sent (e.g., in block 480) in response to the subscription request. In some embodiments, the subscription request can include an identifier of the requested capacity analytic and one or more tuples, with each tuple including the following:
an identifier of a target NF instance or a target NF type;
an indication of whether a capacity dimensioning model is requested for the identified target NF instance or type; and
an indication of committed capacity for the identified target NF instance or instances of the identified target NF type.

In some embodiments, the subscription request also includes a capacity deviation margin associated with the requested capacity analytic.

In some embodiments, obtaining the information from the OAM NF in block 430 can include the operations of sub-blocks 431-432. In sub-block 431, the NWDAF can send, to the OAM NF, a request including one or more tuples corresponding to the one or more target NF instances identified by the subscription request. Each tuple includes an identifier of a target NF instance and a NF type associated with the target NF instance. In sub-block 432, the NWDAF receives the information from the OAM NF in response to the request in sub-block 431.

In some embodiments, the exemplary method can also include the operations of blocks 440-450. In block 440, the NWDAF can send a request to an NRF of the communication network. The request can include one or more tuples corresponding to the one or more target NF instances identified by the subscription request (e.g., in block 420). Each tuple includes an identifier of a target NF instance and a NF type associated with the target NF instance identified by the identifier. In block 450, the NWDAF can receive, from the NRF, NF profile information for the target NF instances identified in the request. The NF profile information for each target NF instance includes one or more of the following: current status, load at a corresponding time (e.g., timestamp), and capacity. In such case, computing the one or more analytics (e.g., in block 470) is further based on the NF profile information.

In some embodiments, the target NF instances are instances of a user plane function (UPF), and the exemplary method also includes the operations of block 460, where the NWDAF can obtain a traffic usage report from the UPF. In such case, computing the one or more analytics (e.g., in block 470) is further based on the traffic usage report.

In some embodiments, the message sent to the consumer NF (e.g., in block 480) includes the following, for each of the computed one or more analytics:
an identifier of the analytic; and
an identifier of a capacity dimensioning model used to compute the analytic, when requested in the subscription request from the consumer NF;
identifiers of target NF instances having capacity deviations;
the respective capacity deviations; and
respective confidence levels or confidence intervals for the capacity deviations.

In some of these embodiments, the message sent to the consumer NF also includes indication of one or more the following, for each target NF instance having capacity deviation: a capacity-limiting resource; a feature causing the capacity deviation; and a duration until the target NF instance will reach a capacity limit.

In some embodiments, the resource usage by the one or more target NF instances (e.g., obtained in block 430) includes respective values of one or more performance counters maintained by the OAM NF for each of the target NF instances. In some embodiments, the resource configuration of the one or more target NF instances (e.g., obtained in block 430) includes indications of one or more of the following, for each of the target NF instances:
characteristics of processing chipset used;
build and/or release of software used;
NF deployment type;
virtual machine (VM) configuration;
number of VMs or physical machines (PMs) currently used;
maximum number of available VMs or PMs;
processing redundancy scheme; and
networking capacity.

In some embodiments, the indication of resource usage by the target NF instances (e.g., obtained in block 430) comprises values for a plurality of performance counters maintained by the OAM NF. In such embodiments, the capacity dimensioning model can be a multiple linear regression ML model based on the plurality of performance counter values and a corresponding plurality of processing costs per data packet, and the one or more analytics computed for each target NF instance are related to total processing (e.g., CPU) load. An example of these embodiments was discussed above.

In some of these embodiments, the exemplary method can also include the operations of block 410, where the NWDAF can train the multiple linear regression ML model based on training data related to hour of day when the target NF has the highest traffic level (e.g., “busy hour”). The training data can include actual processing load and corresponding actual values for the plurality of performance counters.

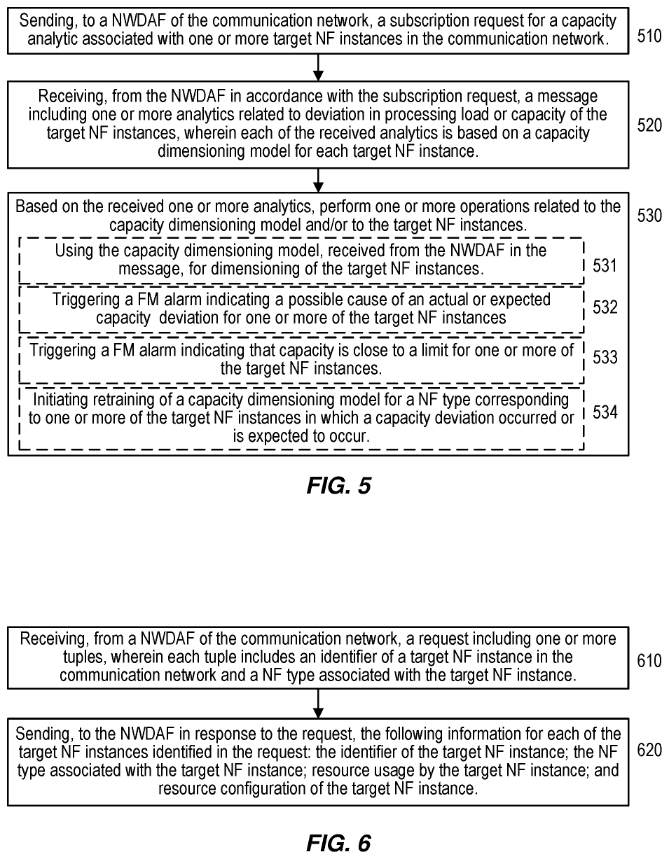

In addition, FIG. 5 illustrates an exemplary method (e.g., procedure) for a consumer NF of a communication network (e.g., 5GC), according to various embodiments of the present disclosure. The exemplary method shown in FIG. 5 can be performed by a NF (or network node hosting the same) that consumes analytics produced by an NWDAF, such as NFs or nodes described elsewhere herein.

The exemplary method can include the operations of block 510, where the consumer NF can send, to a NWDAF of the communication network, a subscription request for a capacity analytic associated with one or more target NF instances in the communication network. The exemplary method can also include the operations of block 520, where the consumer NF can receive, from the NWDAF in accordance with the subscription request, a message including one or more analytics related to deviation in processing load or capacity of the target NF instances. Each received analytic is based on a capacity dimensioning model for each target NF instance. The exemplary method can also include the operations of block 530, where the consumer NF can, based on the capacity analytics, perform one or more operations related to the capacity dimensioning model and/or to the target NF instances.

In some embodiments, the subscription request can include an identifier of the requested capacity analytic and one or more tuples, with each tuple including the following:
an identifier of a target NF instance or a target NF type;
an indication of whether a capacity dimensioning model is requested for the identified target NF instance or type; and
an indication of committed capacity for the identified target NF instance or instances of the identified target NF type.

In some embodiments, the subscription request also includes a capacity deviation margin associated with the requested capacity analytic.

In some embodiments, each of the received analytics can also be based on one or more of the following:
resource usage by the target NF instances and resource configuration of the target NF instances, as maintained by an OAM NF of the communication network;
NF profile information for the target NF instances, as maintained by an NRF of the communication network; and
a traffic usage report by a UPF of the communication network.

In some of these embodiments, the resource usage by the target NF instances is indicated by values for a plurality of performance counters maintained by the OAM NF. In such embodiments, the capacity dimensioning model is a multiple linear regression ML model based on the plurality of performance counter values and a corresponding plurality of processing costs per data packet. In addition, the one or more analytics received for each target NF instance are related to total processing (e.g., CPU) load. An example of these embodiments was discussed above.

In some of these embodiments, the resource configuration of the one or more target NF instances includes indications of one or more of the following, for each of the target NF instances:
characteristics of processing chipset used;
build and/or release of software used;
NF deployment type;
VM configuration;
number of VMs or PMs currently used;
maximum number of available VMs or PMs;
processing redundancy scheme; and
networking capacity.

In some embodiments, the message received from the NWDAF (e.g., in block 520) includes the following, for each of the received analytics:
an identifier of the analytic;
an identifier of a capacity dimensioning model used to compute the analytic, when requested in the subscription request from the consumer NF;
identifiers of target NF instances having capacity deviations;
the respective capacity deviations; and
respective confidence levels or confidence intervals for the capacity deviations.

In some of these embodiments, the message received from the NWDAF also includes indication of one or more the following, for each target NF instance having capacity deviation: a capacity-limiting resource; a feature causing the capacity deviation; and a duration until the target NF instance will reach a capacity limit.

In some embodiments, the one or more operations related to the capacity dimensioning and/or to the target NF instances (e.g., performed in block 530) include any of the following, identified by corresponding sub-block numbers:
(531) using the capacity dimensioning model, received from the NWDAF in the message, for dimensioning of the target NF instances;
(532) triggering a fault management (FM) alarm indicating a possible cause of an actual or expected capacity deviation for one or more of the target NF instances;
(533) triggering a FM alarm indicating that capacity is close to a limit for one or more of the target NF instances; and
(534) initiating retraining of a capacity dimensioning model for a NF type corresponding to one or more of the target NF instances in which a capacity deviation occurred or is expected to occur.

In addition, FIG. 6 illustrates an exemplary method (e.g., procedure) for an OAM NF of a communication network (e.g., 5GC), according to various embodiments of the present disclosure. The exemplary method shown in FIG. 6 can be performed by NF dedicated to OAM or an OAM module of another NF (or network node hosting the same), such as NFs or nodes described elsewhere herein.

The exemplary method can include the operations of block 610, where the OAM NF can receive, from an NWDAF of the communication network, a request including one or more tuples. Each tuple includes an identifier of a target NF instance in the communication network and a NF type associated with the target NF instance. The exemplary method can include the operations of block 620, where the OAM NF can send, to the NWDAF in response to the request, the following information for each of the target NF instances identified in the request:
the identifier of the target NF instance;
the NF type associated with the target NF instance;
resource usage by the target NF instance; and
resource configuration of the target NF instance.

In some embodiments, the resource usage by the one or more target NF instances (e.g., sent in block 620) includes respective values of one or more performance counters maintained by the OAM NF for each of the target NF instances. In some embodiments, the resource configuration of the one or more target NF instances (e.g., sent in block 620) includes indications of one or more of the following, for each of the target NF instances:
characteristics of processing chipset used;
build and/or release of software used;
NF deployment type;
VM configuration;
number of VMs or PMs currently used;
maximum number of available VMs or PMs;
processing redundancy scheme; and
networking capacity.

In some embodiments, for each of target NF instances identified in the request, the response to the request includes a tuple comprising:
the identifier of the target NF instance;
the NF type associated with the target NF instance;
an average usage of virtual CPU resources for the target NF instance;
an average usage of virtual memory resources for the target NF instance;
an average usage of virtual disk storage resources for the target NF instance; and
an indication of resource configuration changes for the target NF instance.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

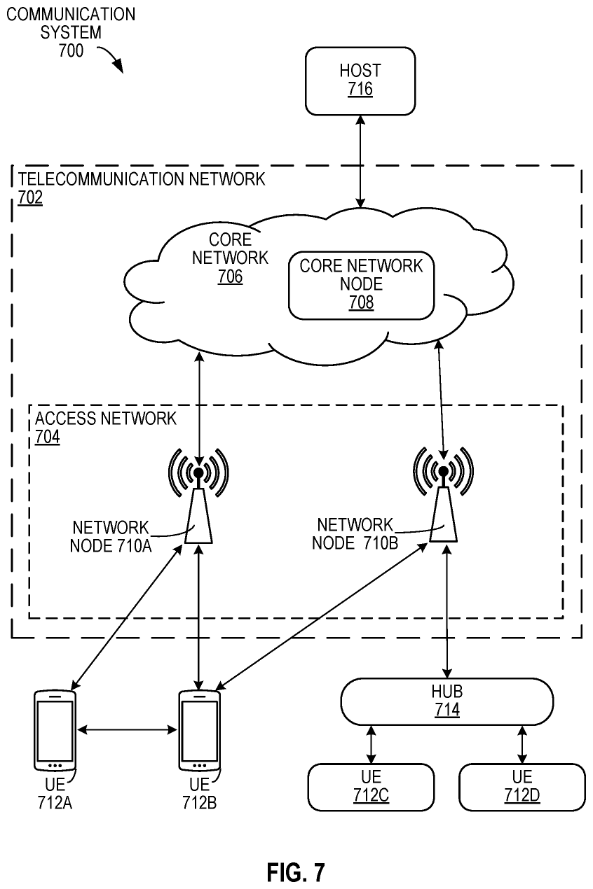

FIG. 7 shows an example of a communication system 700 in accordance with some embodiments. In this example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one or more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708.

Example core network nodes (or functions implemented by such nodes) include one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM) function, Security Edge Protection Proxy (SEPP), Network Exposure Function (NEF), Network Repository Function (NRF), User Plane Function (UPF), Network Data Analytics Function (NWDAF), and operations administration maintenance (OAM) function. At least some of these functions can be consumer NFs such as described elsewhere herein. In some embodiments, different instances of core network node 1108 can perform operations corresponding to exemplary methods or procedures described above as being performed by a consumer NF, an NWDAF, and an OAM NF.

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

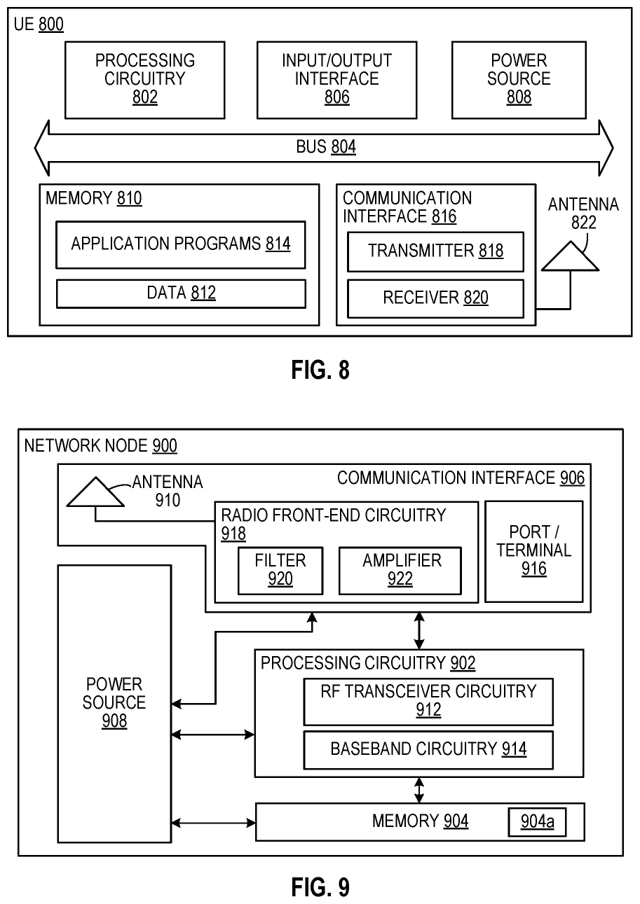

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions (collectively referred to as computer program product 1904a) capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

In some embodiments, different instances of network node 900 (e.g., processing circuitry 902 and communication interface circuitry 906) can be configured to perform operations corresponding to exemplary methods or procedures described above as being performed by a consumer NF, an NWDAF, and an OAM NF.

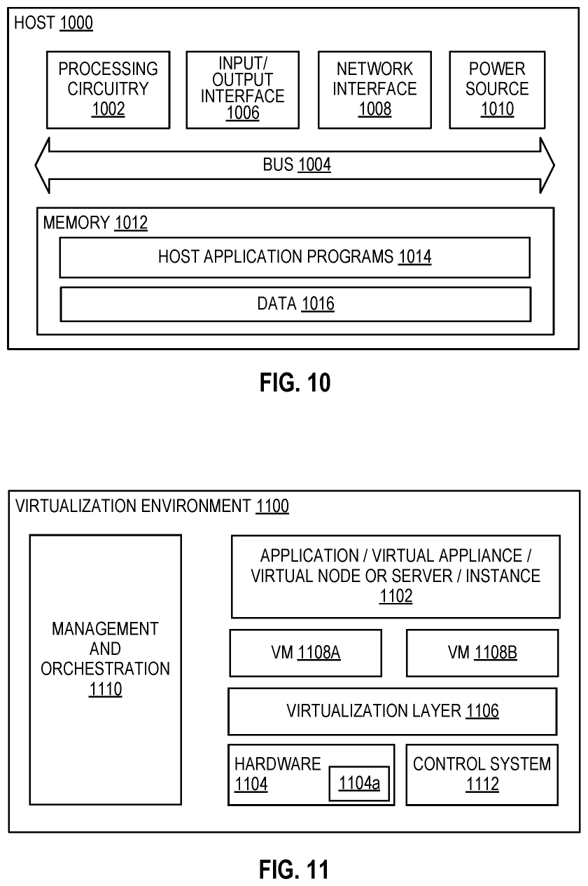

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein. As a specific example, a consumer NF, an NWDAF, and/or an OAM NF that perform respective methods or procedures described above can be instantiated as one or more applications 1102 running in virtualization environment 1100.

Hardware 1104 includes processing circuitry, memory that stores software and/or instructions (designated as computer program product 1104a) executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

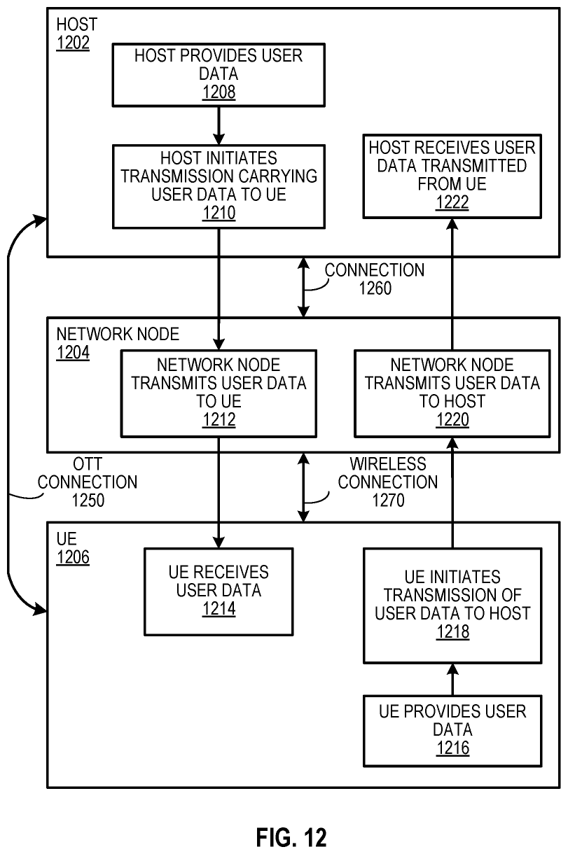

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. Embodiments apply capabilities of 5G networks to detect NF capacity deviations automatically and in real time based on NWDAF analytics. Embodiments can enable consumers (e.g., consumer NF associated with an MNO) to retrieve capacity dimensioning models, to use such models as required, and to trigger fault management (FM) alarms due to capacity deviations. Embodiments facilitate elimination of offline capacity dimensioning tools that may outdated, do not cover all possible deployment variations, and/or require a lot of maintenance and testing efforts. At a high level, embodiments improve management of available capacity in a communication network (e.g., 5GC), which can increase the value of OTT services delivered via the communication network to both service providers and end users.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above or by supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein include, but are not limited to, the following enumerated examples:

A1. A method for a network data analytics function (NWDAF) of a communication network, the method comprising:
obtaining, from an operations administration maintenance (OAM) network function (NF) of the communication network, the following information for each of one or more target NF instances in the communication network:
   an identifier of the target NF instance;
   a NF type associated with the target NF instance;
   resource usage by the target NF instance; and
   resource configuration of the target NF instance;
computing one or more analytics related to deviation in processing load or capacity of the target NF instances, based on the information obtained from the OAM NF and on a capacity dimensioning model for each target NF instance; and
sending, to a consumer NF of the communication network, a message including the computed analytics.

A2. The method of embodiment A1, further comprising receiving, from the consumer NF, a subscription request for a capacity analytic associated with the one or more target NF instances, wherein the computed analytics are sent in response to the subscription request.

A3. The method of embodiment A2, wherein the subscription request includes the following:
an identifier of the capacity analytic; and
one or more tuples, each tuple including:
   an identifier of a target NF instance or a target NF type;
   an indication of whether a capacity dimensioning model is requested for the identified target NF instance or type; and
   an indication of committed capacity for the identified target NF instance or instances of the identified target NF type.

A4. The method of any of embodiments A2-A3, wherein the subscription request also includes a capacity deviation margin associated with the capacity analytic.

A5. The method of any of embodiments A3-A4, wherein obtaining the information from the OAM NF of the communication network comprises:
sending, to the OAM NF, a request including one or more tuples corresponding to the one or more target NF instances identified by the subscription request, wherein each tuple includes an identifier of a target NF instance and a NF type associated with the target NF instance; and
receiving the information from the OAM NF in response to the request.

A6. The method of any of embodiments A3-A5, further comprising:
sending a request to a network repository function (NRF) of the communication network, the request including one or more tuples corresponding to the one or more target NF instances identified by the subscription request, wherein each tuple includes an identifier of a target NF instance and a NF type associated with the target NF instance; and
receiving, from the NRF, NF profile information for the target NF instances identified in the request, wherein the NF profile information for each target NF instance includes one or more of the following: current status, load at a corresponding time, and capacity.

A7. The method of any of embodiments A3-A6, wherein:
the target NF instances are instances of a user plane function (UPF);
the method further comprises obtaining a traffic usage report from the UPF; and computing the one or more analytics is further based on the traffic usage report.

A8. The method of any of embodiments A2-A7, wherein the message sent to the consumer NF includes the following, for each of the one or more capacity analytics:
an identifier of the capacity analytic; and
an identifier of a capacity dimensioning model used to compute the capacity analytic, when requested in the subscription request from the consumer NF;
identifiers of target NF instances having capacity deviations;
the respective capacity deviations; and
respective confidence levels or confidence intervals for the capacity deviations.

A9. The method of embodiment A8, wherein the message sent to the consumer NF also includes indication of one or more the following, for each target NF instance having capacity deviation:
a capacity-limiting resource;
a feature causing the capacity deviation; and
a duration until the target NF instance will reach a capacity limit.

A10. The method of any of embodiments A1-A9, wherein the resource usage by the one or more target NF instances includes respective values of one or more performance counters maintained by the OAM NF for each of the target NF instances.

A11. The method of any of embodiments A1-A10, wherein the resource configuration of the one or more target NF instances includes indications of one or more of the following, for each of the target NF instances:
characteristics of processing chipset used;
build and/or release of software used;
NF deployment type;
virtual machine (VM) configuration;
number of VMs or physical machines (PMs) currently used;
maximum number of available VMs or PMs;
processing redundancy scheme; and
networking capacity.

A12. The method of any of embodiments A1-A11, wherein:
the obtained resource usage by the target NF instances comprises values for a plurality of performance counters maintained by the OAM NF;
the capacity dimensioning model is a multiple linear regression machine learning (ML) model based on the plurality of performance counter values and a corresponding plurality of processing costs per data packet; and the capacity analytic for each target NF instance is a total processing load.

A13. The method of embodiment A12, further comprising training the multiple linear regression ML model based on training data obtained during hour of day when the target NF has the highest traffic level, wherein the training data includes actual processing load and corresponding actual values for the plurality of performance counters.

B1. A method for a consumer network function (NF) of a communication network, the method comprising:
sending, to a network data analytics function (NWDAF) of the communication network, a subscription request for analytics related to deviation in processing load or capacity of one or more target network function (NF) instances in the communication network;
receiving, from the NWDAF, a message including one or more capacity analytics in accordance with the subscription request, wherein each capacity analytic is based on a capacity dimensioning model for each target NF instance; and based on the capacity analytics, performing one or more operations related to the capacity dimensioning model and/or to the target NF instances.

B2. The method of embodiment B1, wherein the subscription request includes the following:
an identifier of the capacity analytic; and
one or more tuples, each tuple including:
   an identifier of a target NF instance or a target NF type;
   an indication of whether a capacity dimensioning model is requested for the identified target NF instance or type; and
   an indication of committed capacity for the identified target NF instance or instances of the identified target NF type.

B3. The method of embodiments B2, wherein the subscription request also includes a capacity deviation margin associated with the capacity analytic.

B4. The method of any of embodiments B1-B3, wherein each capacity analytic is also based on one or more of the following:
resource usage by the target NF instances and resource configuration of the target NF instances, as maintained by an operations administration maintenance (OAM) network function (NF) of the communication network;
NF profile information for the target NF instances, as maintained by a network repository function (NRF) of the communication network; and
a traffic usage report by a user plane function (UPF) of the communication network.

B5. The method of embodiment B4, wherein:
the resource usage by the target NF instances comprises values for a plurality of performance counters maintained by the OAM NF;
the capacity dimensioning model is a multiple linear regression machine learning (ML) model based on the plurality of performance counter values and a corresponding plurality of processing costs per data packet; and
the capacity analytic for each target NF instance is a total processing load.

B6. The method of any of embodiments B4-B5, wherein the resource configuration of the one or more target NF instances includes one or more of the following, for each of the target NF instances:
characteristics of processing chipset used;
build and/or release of software used;
NF deployment type;
virtual machine (VM) configuration;
number of VMs or physical machines (PMs) currently used;
maximum number of available VMs or PMs;
processing redundancy scheme; and
networking capacity.

B7. The method of any of embodiments B1-B6, wherein the message received from the NWDAF includes the following, for each of the one or more capacity analytics:
an identifier of the capacity analytic;
an identifier of a capacity dimensioning model used to compute the capacity analytic, when requested in the subscription request from the consumer NF;
identifiers of target NF instances having capacity deviations;
the respective capacity deviations; and
respective confidence levels or confidence intervals for the capacity deviations.

B8. The method of embodiment B7, wherein the message received from the NWDAF also includes indication of one or more the following, for each target NF instance having capacity deviation:
a capacity-limiting resource.
a feature causing the capacity deviation;
a duration until the target NF instance will reach a capacity limit.

B9. The method of any of embodiments B1-B8, wherein the one or more operations related to the capacity dimensioning and/or to the target NF instances include any of the following:
using the capacity dimensioning model, received from the NWDAF in the message, for dimensioning of the target NF instances;
triggering a fault management (FM) alarm indicating a possible cause of an actual or expected capacity deviation for one or more of the target NF instances;
triggering a FM alarm indicating that capacity is close to a limit for one or more of the target NF instances; and
initiating retraining of a capacity dimensioning model for a NF type corresponding to one or more of the target NF instances in which a capacity deviation occurred or is expected to occur.

C1. A method for an operations administration maintenance (OAM) network function (NF) of a communication network, the method comprising:
receiving, from a network data analytics function (NWDAF) of the communication network, a request including one or more tuples, wherein each tuple includes an identifier of a target network function (NF) instance in the communication network and a NF type associated with the target NF instance; and
sending, to the NWDAF in response to the request, the following information for each of the target NF instances identified in the request:
   the identifier of the target NF instance;
   the NF type associated with the target NF instance;
   resource usage by the target NF instance; and
   resource configuration of the target NF instance.

C2. The method of embodiment C1, wherein the resource usage by the one or more target NF instances includes respective values of one or more performance counters maintained by the OAM NF for each of the target NF instances.

C3. The method of any of embodiments C1-C2, wherein the resource configuration of the one or more target NF instances includes indications of one or more of the following, for each of the target NF instances:
characteristics of processing chipset used;
build and/or release of software used;
NF deployment type;
virtual machine (VM) configuration;
number of VMs or physical machines (PMs) currently used;
maximum number of available VMs or PMs;
processing redundancy scheme; and
networking capacity.

C4. The method of any of embodiments C1-C3, wherein for each of target NF instances identified in the request, the response to the request includes a tuple comprising:
the identifier of the target NF instance;
the NF type associated with the target NF instance;
an average usage of virtual CPU resources for the target NF instance;
an average usage of virtual memory resources for the target NF instance;
an average usage of virtual disk storage resources for the target NF instance; and
an indication of resource configuration changes for the target NF instance.

D1. A network data analytics function (NWDAF) of a communication network, wherein:
the NWDAF is implemented by communication interface circuitry and processing circuitry that are operably coupled and configured to communicate with at least a consumer network function (NF) and an operations administration maintenance (OAM) NF; and
the processing circuitry and interface circuitry are configured to perform operations corresponding to any of the methods of embodiments A1-A13.

D2. A network data analytics function (NWDAF) of a communication network, the NWDAF being configured to perform operations corresponding to any of the methods of embodiments A1-A13.

D3. A non-transitory, computer-readable medium storing computer-executable instructions that, when executed by processing circuitry associated with a network data analytics function (NWDAF) of a communication network, configure the NWDAF to perform operations corresponding to any of the methods of embodiments A1-A13.

D4. A computer program product comprising computer-executable instructions that, when executed by processing circuitry associated with a network data analytics function (NWDAF) of a communication network, configure the NWDAF to perform operations corresponding to any of the methods of embodiments A1-A13.

E1. A consumer network function (NF) of a communication network, wherein:
the consumer NF is implemented by communication interface circuitry and processing circuitry that are operably coupled and configured to communicate with a network data analytics function (NWDAF) of the communication network; and
the processing circuitry and interface circuitry are configured to perform operations corresponding to any of the methods of embodiments B1-B9.

E2. A consumer network function (NF) of a communication network, the consumer NF being configured to perform operations corresponding to any of the methods of embodiments B1-B9.

E3. A non-transitory, computer-readable medium storing computer-executable instructions that, when executed by processing circuitry associated with a consumer network function (NF) of a communication network, configure the consumer NF to perform operations corresponding to any of the methods of embodiments B1-B9.

E4. A computer program product comprising computer-executable instructions that, when executed by processing circuitry associated with a consumer network function (NF) of a communication network, configure the consumer NF to perform operations corresponding to any of the methods of embodiments B1-B9.

F1. An operations administration maintenance (OAM) network function (NF) of a communication network, wherein:
the OAM NF is implemented by communication interface circuitry and processing circuitry that are operably coupled and configured to communicate with a network data analytics function (NWDAF) of the communication network; and
the processing circuitry and interface circuitry are configured to perform operations corresponding to any of the methods of embodiments C1-C4.

F2. An operations administration maintenance (OAM) network function (NF) of a communication network, the OAM NF being configured to perform operations corresponding to any of the methods of embodiments C1-C4.

F3. A non-transitory, computer-readable medium storing computer-executable instructions that, when executed by processing circuitry associated with an operations administration maintenance (OAM) network function (NF) of a communication network, configure the OAM NF to perform operations corresponding to any of the methods of embodiments C1-C4.

F4. A computer program product comprising computer-executable instructions that, when executed by processing circuitry associated with an operations administration maintenance (OAM) network function (NF) of a communication network, configure the OAM NF to perform operations corresponding to any of the methods of embodiments C1-C4.

1.-44. (canceled)

45. A method for a network data analytics function (NWDAF) of a communication network, the method comprising:
obtaining, from an operations administration maintenance (OAM) network function (NF) of the communication network, the following information for each of one or more target NF instances in the communication network:
an identifier of the target NF instance;
a NF type associated with the target NF instance;
indication of resource usage by the target NF instance; and
resource configuration of the target NF instance;
computing one or more analytics related to deviation in processing load or capacity of the target NF instances, based on the information obtained from the OAM NF and on a capacity dimensioning model for each target NF instance; and
sending, to a consumer NF of the communication network, a message including the computed one or more analytics.

46. The method of claim 45, further comprising receiving, from the consumer NF, a subscription request for a capacity analytic associated with the one or more target NF instances, wherein:
the computed one or more analytics are sent in response to the subscription request; and
the subscription request includes the following:
an identifier of the requested capacity analytic; and
one or more tuples, each tuple including:
an identifier of a target NF instance or a target NF type;
an indication of whether a capacity dimensioning model is requested for the identified target NF instance or type; and
an indication of committed capacity for the identified target NF instance or instances of the identified target NF type.

47. The method of claim 46, wherein obtaining the information from the OAM NF of the communication network comprises:
sending, to the OAM NF, a request including one or more tuples corresponding to the one or more target NF instances identified by the subscription request, wherein each tuple includes an identifier of a target NF instance and a NF type associated with the target NF instance; and
receiving the information from the OAM NF in response to the request.

48. The method of claim 46, further comprising:
sending a request to a network repository function (NRF) of the communication network, wherein the request includes one or more tuples corresponding to the one or more target NF instances identified by the subscription request, wherein each tuple includes an identifier of a target NF instance and a NF type associated with the target NF instance; and
receiving, from the NRF, NF profile information for the target NF instances identified in the request, wherein the NF profile information for each target NF instance includes one or more of the following: current status, load at a corresponding time, and capacity.

49. The method of claim 46, wherein:
the target NF instances are instances of a user plane function (UPF);
the method further comprises obtaining a traffic usage report from the UPF; and
computing the one or more analytics is further based on the traffic usage report.

50. The method of claim 46, wherein the message sent to the consumer NF includes the following, for each of the computed one or more analytics:
an identifier of the analytic; and
an identifier of a capacity dimensioning model used to compute the analytic, when requested in the subscription request from the consumer NF;
identifiers of target NF instances having capacity deviations;
the respective capacity deviations; and
respective confidence levels or confidence intervals for the capacity deviations.

51. The method of claim 45, wherein the resource configuration of the one or more target NF instances includes indications of one or more of the following, for each of the target NF instances:
characteristics of processing chipset used;
build and/or release of software used;
NF deployment type;
virtual machine (VM) configuration;
number of VMs or physical machines (PMs) currently used;
maximum number of available VMs or PMs;
processing redundancy scheme; and
networking capacity.

52. The method of claim 45, wherein:
the indication of resource usage by the target NF instances comprises values for a plurality of performance counters maintained by the OAM NF;
the capacity dimensioning model is a multiple linear regression machine learning (ML) model based on the plurality of performance counter values and on a corresponding plurality of processing costs per data packet; and
the one or more analytics computed for each target NF instance are related to total processing load.

53. A method for a consumer network function (NF) of a communication network, the method comprising:
sending, to a network data analytics function (NWDAF) of the communication network, a subscription request for a capacity analytic associated with one or more target network NF instances in the communication network;
receiving, from the NWDAF in accordance with the subscription request, a message including one or more analytics related to deviation in processing load or capacity of the target NF instances, wherein each of the received analytics is based on a capacity dimensioning model for each target NF instance; and
based on the received one or more analytics, performing one or more operations related to one or more of the following: the capacity dimensioning model, and the target NF instances.

54. The method of claim 53, wherein the subscription request includes the following:
an identifier of the requested capacity analytic; and
one or more tuples, each tuple including:
an identifier of a target NF instance or a target NF type;
an indication of whether a capacity dimensioning model is requested for the identified target NF instance or type; and
an indication of committed capacity for the identified target NF instance or instances of the identified target NF type.

55. The method of claim 53, wherein each of the received analytics is also based on one or more of the following:
resource usage by the target NF instances and resource configuration of the target NF instances, as maintained by an operations administration maintenance (OAM) network NF of the communication network;
NF profile information for the target NF instances, as maintained by a network repository function (NRF) of the communication network; and
a traffic usage report by a user plane function (UPF) of the communication network.

56. The method of claim 55, wherein:
the resource usage by the target NF instances is indicated by values for a plurality of performance counters maintained by the OAM NF;
the capacity dimensioning model is a multiple linear regression machine learning (ML) model based on the plurality of performance counter values and a corresponding plurality of processing costs per data packet; and
the one or more analytics received for each target NF instance are related to total processing load.

57. The method of claim 55, wherein the resource configuration of the one or more target NF instances includes one or more of the following, for each of the target NF instances:
characteristics of processing chipset used;
build and/or release of software used;
NF deployment type;
virtual machine (VM) configuration;
number of VMs or physical machines (PMs) currently used;
maximum number of available VMs or PMs;
processing redundancy scheme; and
networking capacity.

58. The method of claim 53, wherein the message received from the NWDAF includes the following, for each of the received analytics:
an identifier of the analytic;
an identifier of a capacity dimensioning model used to compute the analytic, when requested in the subscription request from the consumer NF;
identifiers of target NF instances having capacity deviations;
the respective capacity deviations; and
respective confidence levels or confidence intervals for the capacity deviations.

59. The method of claim 53, wherein the one or more operations related to the capacity dimensioning and/or to the target NF instances include any of the following:
using the capacity dimensioning model, received from the NWDAF in the message, for dimensioning of the target NF instances;
triggering a fault management, FM, alarm indicating a possible cause of an actual or expected capacity deviation for one or more of the target NF instances;
triggering a FM alarm indicating that capacity is close to a limit for one or more of the target NF instances; and
initiating retraining of a capacity dimensioning model for a NF type corresponding to one or more of the target NF instances in which a capacity deviation occurred or is expected to occur.

60. A method for an operations administration maintenance (OAM) network function (NF) of a communication network, the method comprising:
receiving, from a network data analytics function (NWDAF) of the communication network, a request including one or more tuples, wherein each tuple includes an identifier of a target network NF instance in the communication network and a NF type associated with the target NF instance; and
sending, to the NWDAF in response to the request, the following information for each of the target NF instances identified in the request:
the identifier of the target NF instance;
the NF type associated with the target NF instance;
an indication of resource usage by the target NF instance; and
resource configuration of the target NF instance.

61. The method of claim 60, wherein the resource configuration of the one or more target NF instances includes indications of one or more of the following, for each of the target NF instances:
characteristics of processing chipset used;
build and/or release of software used;
NF deployment type;
virtual machine (VM) configuration;
number of VMs or physical machines (PMs) currently used;
maximum number of available VMs or PMs;
processing redundancy scheme; and
networking capacity.

62. The method of claim 61, wherein for each of target NF instances identified in the request, the response to the request includes a tuple comprising:
the identifier of the target NF instance;
the NF type associated with the target NF instance;
an average usage of virtual CPU resources for the target NF instance;
an average usage of virtual memory resources for the target NF instance;
an average usage of virtual disk storage resources for the target NF instance; and
an indication of resource configuration changes for the target NF instance.

63. Network equipment configured to implement a network data analytics function (NWDAF) of a communication network, wherein the network equipment comprises:
communication interface circuitry configured to communicate with at least a consumer network function (NF) and an operations administration maintenance (OAM) NF of the communication network; and
processing circuitry operably coupled to the communication interface circuitry, wherein the processing circuitry and the communication interface circuitry are configured to perform the method of claim 45.

64. Network equipment configured to implement a consumer network function (NF) of a communication network, wherein the network equipment comprises:
communication interface circuitry configured to communicate with a network data analytics function (NWDAF) of the communication network; and
processing circuitry operably coupled to the communication interface circuitry, wherein the processing circuitry and the communication interface circuitry are configured to perform the method of claim 53.

65. Network equipment configured to implement an operations administration maintenance (OAM) network function (NF) of a communication network, wherein the network equipment comprises:
communication interface circuitry configured to communicate with a network data analytics function (NWDAF) of the communication network; and
processing circuitry operably coupled to the communication interface circuitry, wherein the processing circuitry and the communication interface circuitry are configured to perform the method of claim 60.
